(19) United States
(12) Patent Application Publication
(10) Pub. No.: US 2025/0137238 A1
(43) Pub. Date: May 1, 2025

(54) ATTACHMENT POSITION DETERMINING METHOD, WORK IMPLEMENT, WORK MACHINE, AND POSTURAL DETECTION SENSOR

(71) Applicant: KOMATSU LTD., Tokyo (JP)

(72) Inventors: Takashi SAKAI, Tokyo (JP); Hayato HISA

(21) Appl. No.: 18/835,791

(22) PCT Filed: Feb. 21, 2023
(86) PCT No.: PCT/JP2023/006292

§ 371 Date: Aug. 5, 2024

(30) Foreign Application Priority Data
Apr. 28, 2022 (JP) 2022-075379

(51) Int. Cl. E02F 9/26; E02F 3/36; E02F 3/40; E02F 9/22

(52) U.S. Cl. CPC E02F 9/264; E02F 3/3604; E02F 3/40; E02F 9/2228

(57) ABSTRACT

An attachment position determining method includes obtaining a first straight line connecting base and distal end portions a link member in a design phase, obtaining a flexure curve indicating a flexed state of the link member, obtaining a second straight line connecting the base end portion and the distal end portion on the flexure curve, obtaining a first angle formed between the first straight line and the second straight line, obtaining a second angle formed between the first straight line and a tangent line of the flexure curve, determining a position on the flexure curve as a reference position such that the second angle is equal to the first angle, and determining an attachment position of a postural detection sensor on the link member based on positional information in a lengthwise direction of the link member. The flexure curve is obtained based on the first straight line.

### CROSS-REFERENCE TO RELATED APPLICATIONS

This application is a U.S. National stage application of International Application No. PCT/JP2023/006292, filed on Feb. 21, 2023. This U.S. National stage application claims priority under 35 U.S.C. § 119(a) to Japanese Patent Application No. 2022-075379, filed in Japan on Apr. 28, 2022, the entire contents of which are hereby incorporated herein by reference.

### BACKGROUND

### Technical Field

The present disclosure relates to an attachment position determining method, a work implement, a work machine, and a postural detection sensor.

### Background Information

There has been known a technology for calculating the position of the cutting edge of a bucket provided as an attachment in a work machine including a work implement. For example, a work machine described in Domestic Re-publication of PCT International Application No. WO2016/056676 includes a vehicle body and a work implement. To detect the position of the vehicle body, an antenna for a GNSS (Global Navigation Satellite System), for instance, is mounted to the vehicle body. Besides, an IMU (Inertial Measurement Unit), for instance, is disposed in the vehicle body. The IMU detects the roll angle, the pitch angle, and so forth of the vehicle body. The work implement includes a boom, an arm, a bucket, and hydraulic cylinders for driving the components. A controller for the work machine calculates the position of the cutting edge of the bucket based on the position and posture of the vehicle body, the dimensions of components of the work implement, the rotating angles of the components of the work implement, and so forth.

On the other hand, Japan Laid-open Patent Application Publication No. 2019-132038 discloses a configuration that IMUs (Inertial Measurement Units), by which the posture of a boom, that of an arm, and that of a bucket are detected, are attached in the vicinity of a pivot shaft of the boom, that of the arm, and that of the bucket, respectively, to accurately detect the posture of the attachment.

### SUMMARY

However, when calculated with values detected by the IMUs, the position of the cutting edge of the bucket is derived on the premise that the work implement is a rigid body; hence, the calculated position of the cutting edge has a margin of error with respect to the position of the cutting edge in the actual work implement that flexure could occur. Such a margin of error is likely to become imminent with increase in dimension of the work implement.

It is an object of the present disclosure to provide an attachment position determining method, a work implement, a work machine, and a postural detection sensor, whereby it is made possible to reduce a detection error caused in postural detection due to inconsideration of flexure.

An attachment position determining method according to a first aspect of the present disclosure relates to a method of determining an attachment position for a postural detection sensor in a work implement including a link member, a posture of which is detected by the postural detection sensor. The method includes obtaining a first straight line connecting a base end portion and a distal end portion of the link member in a design phase, obtaining a flexure curve indicating a flexed state of the link member, the flexure curve obtained based on the first straight line, obtaining a second straight line connecting the base end portion and the distal end portion on the flexure curve, obtaining a first angle formed between the first straight line and the second straight line, obtaining a second angle formed between the first straight line and a tangent line of the flexure curve, determining a position on the flexure curve as a reference position such that the second angle is equal to the first angle, and determining the attachment position for the postural detection sensor on the link member based on positional information in a lengthwise direction of the link member among positional information of the reference position.

A work implement according to a second aspect of the present disclosure includes a link member and an attachment position. The link member includes a base end portion and a distal end portion. The attachment position is located in a position determined by the attachment position determining method according to the first aspect.

A work implement according to a third aspect of the present disclosure includes a link member and a postural detection sensor. The link member includes a base end portion and a distal end portion. The postural detection sensor is attached to an attachment position for the postural detection sensor on the link member and detects a posture of the link member. The attachment position is a position determined by the method of determining an attachment position according to the first aspect.

A work machine according to a fourth aspect of the present disclosure includes a lower structure, a revolving unit, and the work implement according to either the second or third aspect. The revolving unit is disposed to be revolvable on an upper side of the lower structure. The work implement is rotatably attached to the revolving unit at the base end portion of the link member. The work implement further includes a second link member rotatably attached to the distal end portion of the link member and an attachment attached to the second link member.

A postural detection sensor according to a fifth aspect of the present disclosure relates to a postural detection sensor attachable to an attachment position for the postural detection sensor on a link member to detect a posture of the link member. The attachment position is a position determined by the attachment position determining method according to the first aspect.

According to the present disclosure, it is made possible to provide an attachment position determining method, a work implement, a work machine, and a postural detection sensor, whereby it is made possible to reduce a detection error caused in postural detection due to inconsideration of flexure.

### BRIEF DESCRIPTION OF THE DRAWINGS

FIG. 1 is a perspective view of a work machine in a preferred embodiment according to the present disclosure.

FIG. 2 is a block diagram showing a configuration of a drivetrain and a control system for the work machine in the preferred embodiment according to the present disclosure.

FIG. 3 is a schematic diagram of a configuration of the work machine in the preferred embodiment according to the present disclosure.

FIG. 4 is a side view of a posture taken by a work implement such that horizontal distance between a bucket and a base end portion of a boom becomes the longest in the preferred embodiment according to the present disclosure.

FIG. 5 is a chart showing variation in flexure amount in a direction oriented perpendicular to a lengthwise direction of the boom with respect to coordinates in the lengthwise direction of the boom at the posture shown in FIG. 4.

FIG. 6 is a side view of a posture taken by the work implement such that an arm is oriented along an up-and-down direction in the preferred embodiment according to the present disclosure.

FIG. 7 is a chart showing variation in flexure amount in the direction oriented perpendicular to the lengthwise direction of the boom with respect to the coordinates in the lengthwise direction of the boom at the posture shown in FIG. 6.

FIG. 8 is a flowchart for explaining a method of attaching a boom angle sensor to the boom.

### DETAILED DESCRIPTION OF EMBODIMENT(S)

A work implement, a work machine, a boom, a postural detection sensor, and a method of attaching the postural detection sensor according to a preferred embodiment of the present disclosure will be hereinafter explained with reference to drawings.

### (Overview of Work Machine 1)

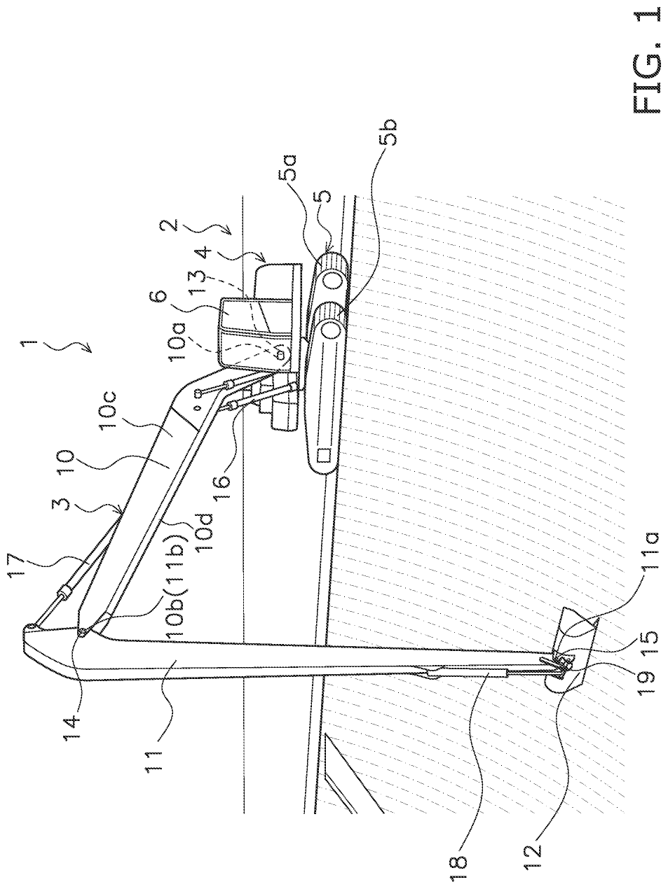

FIG. 1 is a perspective view of a work machine 1 according to the preferred embodiment.

The work machine 1 mainly includes a vehicle body 2 (exemplary work machine body) and a work implement 3. The vehicle body 2 includes a revolving unit 4 and a lower structure 5. The revolving unit 4 is disposed on the upper side of the lower structure 5. The revolving unit 4 is supported to be revolvable relative to the lower structure 5. A cab 6 is disposed on the revolving unit 4. The lower structure 5 includes crawler belts 5a and 5b. The work machine 1 travels by circulating the crawler belts 5a and 5b.

### (Work Implement 3)

The work implement 3 is attached to the vehicle body 2. The work implement 3 includes a boom 10, an arm 11, and a bucket 12. The boom 10 is an exemplary link member. The arm 11 is an exemplary link member or an exemplary second link member.

The boom 10 is rotatably attached to the revolving unit 4 through a boom pin 13. The arm 11 is rotatably attached to a boom top 10b of the boom 10 through an arm pin 14. The bucket 12 is rotatably attached to the arm 11 through a bucket pin 15. It should be noted that a portion of the boom 10, to which the boom pin 13 is attached, is defined as a boom foot 10a. A portion of the boom 10, to which the arm pin 14 is attached, is defined as the boom top 10b. The boom foot 10a corresponds to an exemplary base end portion of a boom, whereas the boom top 10b corresponds to an exemplary distal end portion of the boom. A portion 11b (the reference sign thereof is shown within parentheses next to 10b) of the arm 11, to which the arm pin 14 is attached, corresponds to an exemplary base end portion of an arm, whereas a portion 11a of the arm 11, to which the bucket pin 15 is attached, corresponds to an exemplary distal end portion of the arm.

The work implement 3 includes a pair of boom cylinders 16, an arm cylinder 17, and a bucket cylinder 18. The boom cylinders 16, the arm cylinder 17, and the bucket cylinder 18 are each hydraulic cylinders.

The pair of boom cylinders 16 is disposed, while the boom 10 is interposed therebetween. Each boom cylinder 16 is rotatably attached at the bottom-side end thereof to the revolving unit 4. Each boom cylinder 16 is rotatably attached at the rod-side end thereof to the boom 10.

The arm cylinder 17 is rotatably attached at the bottom-side end thereof to the boom 10. The arm cylinder 17 is rotatably attached at the rod-side end thereof to the arm 11.

The bucket cylinder 18 is rotatably attached at the bottom-side end thereof to the arm 11. The bucket cylinder 18 is rotatably attached at the rod-side end thereof to the bucket 12 through a link 19.

With expansion and contraction of the boom cylinders 16, the boom 10 is rotated in the up-and-down direction. With expansion and contraction of the arm cylinder 17, the arm 11 is rotated with respect to the boom 10. With expansion and contraction of the bucket cylinder 18, the bucket 12 is rotated with respect to the arm 11.

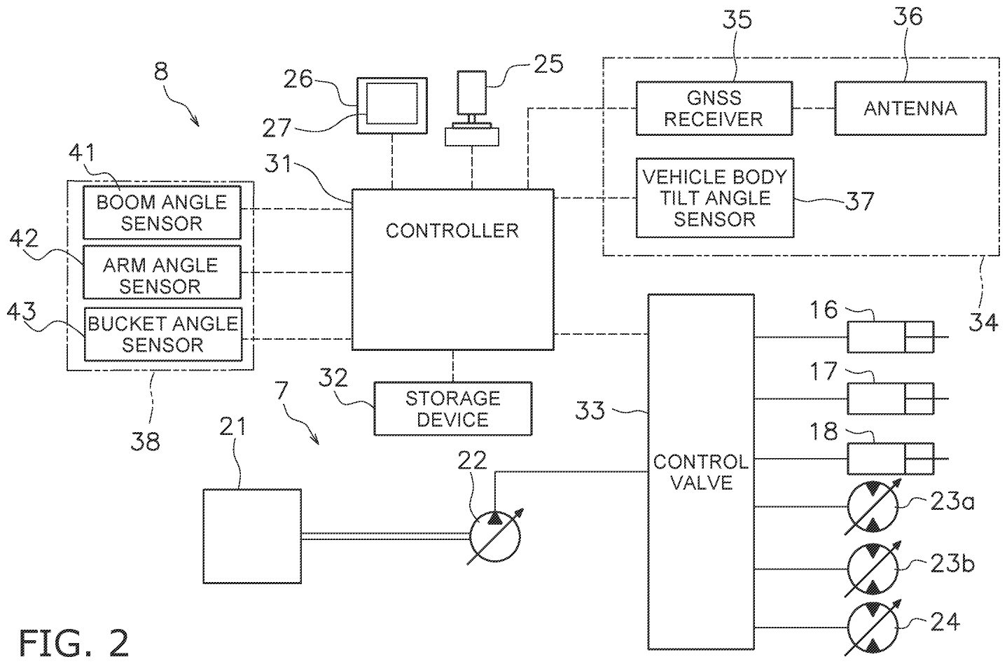

The work machine 1 further includes a drivetrain 7 and a control system 8. FIG. 2 is a block diagram showing a configuration of the drivetrain 7 and the control system 8 in the work machine 1. As shown in FIG. 2, the drivetrain 7 includes a drive source 21 and a hydraulic pump 22. The drive source 21 is, for instance, an internal combustion engine. It should be noted that the drive source may be an electric motor or alternatively a hybrid mechanism of an engine and an electric motor. The hydraulic pump 22 is driven by the drive source 21 and discharges a hydraulic oil. The hydraulic oil discharged from the hydraulic pump 22 is supplied to the boom cylinders 16, the arm cylinder 17, and the bucket cylinder 18.

The work machine 1 includes a first traveling motor 23a, a second traveling motor 23b, and a revolving motor 24. The first traveling motor 23a drives the crawler belt 5a. The second traveling motor 23b drives the crawler belt 5b. The revolving motor 24 revolves the revolving unit 4. The hydraulic oil discharged from the hydraulic pump 22 is supplied to the first traveling motor 23a, the second traveling motor 23b, and the revolving motor 24. It should be noted that the single hydraulic pump 22 is shown in FIG. 2; alternatively, a plurality of hydraulic pumps may be provided.

### (Control System 8)

FIG. 2 is a block diagram showing a configuration of the control system 8.

As shown in FIG. 2, the control system 8 includes an operating device 25, an input device 26, and a display 27. The operating device 25, the input device 26, and the display 27 are disposed in the cab 6. The operating device 25 is a device for operating the work implement 3, the revolving unit 4, and the lower structure 5. The operating device 25 receives operations performed by an operator for driving the work implement 3, the revolving unit 4, and the lower structure 5 and outputs operating signals in accordance with the operations. The operating device 25 includes, for instance, a lever, a pedal, a switch, and so forth.

The input device 26 receives operations performed by the operator for setting controls of the work machine 1 and outputs operating signals in accordance with the operations. The input device 26 is, for instance, a touchscreen. Alternatively, the input device 26 may include one or more levers or one or more switches. The display 27 displays images depending on command signals inputted thereto. The display 27 displays screens for setting the controls of the work machine 1. Besides, the display 27 displays guide screens for assisting works performed by the work machine 1.

The control system 8 includes a controller 31, a storage device 32, and a control valve 33. The controller 31 is programmed to control the work machine 1 based on obtained data. The controller 31 includes a processor such as a CPU (Central Processing Unit) and memories such as a RAM (Random Access Memory) and a ROM (Read Only Memory). The storage device 32 includes a semiconductor memory, a hard disk drive, or so forth. The storage device 32 is an exemplary non-transitory recording medium readable by the controller 31. Computer commands executable by the processor to control the work machine 1 have been recorded in the storage device 32.

The controller 31 obtains the operating signals from the operating device 25 and the input device 26. The controller 31 controls the control valve 33 based on the operating signals. The control valve 33 is controlled by command signals transmitted thereto from the controller 31. It should be noted that the control valve 33 may be a pressure proportional control valve. Alternatively, the control valve 33 may be an electromagnetic proportional control valve. The control valve 33 controls the flow rate of the hydraulic oil to be supplied to each of the first and second traveling motors 23a and 23b from the hydraulic pump 22. Accordingly, the work machine 1 travels depending on the operations of the operating device 25. The control valve 33 controls the flow rate of the hydraulic oil to be supplied to each of the boom cylinders 16, the arm cylinder 17, and the bucket cylinder 18 from the hydraulic pump 22. The controller 31 generates command signals to be transmitted to the control valve 33 such that the boom 10, the arm 11, and the bucket 12 operate depending on the operations of the operating device 25. The control valve 33 controls the flow rate of the hydraulic oil to be supplied to the revolving motor 24 from the hydraulic pump 22. The controller 31 generates command signals to be transmitted to the control valve 33 such that the revolving unit 4 revolves depending on the operations of the operating device 25.

The control system 8 includes a position sensor 34. The position sensor 34 measures the position of the work machine 1. The position sensor 34 is disposed in the vehicle body 2. The position sensor 34 includes a GNSS (Global Navigation Satellite System) receiver 35, an antenna 36, and a vehicle body tilt angle sensor 37. The GNSS receiver 35 is, for instance, a receiver for GPS (Global Positioning System). The GNSS receiver 35 receives positioning signals from satellites and generates vehicle body position data by computing the position of the antenna 36 from the positioning signals. The controller 31 obtains the vehicle body position data from the GNSS receiver 35. The vehicle body tilt angle sensor 37 is an IMU (Inertial Measurement Unit). The vehicle body tilt angle sensor 37 obtains tilt angle data. The tilt angle data include an angle formed by the back-and-forth direction of the vehicle with respect to a horizontal plane (i.e., pitch angle) and an angle formed by the transverse direction of the vehicle with respect to the horizontal plane (i.e., roll angle).

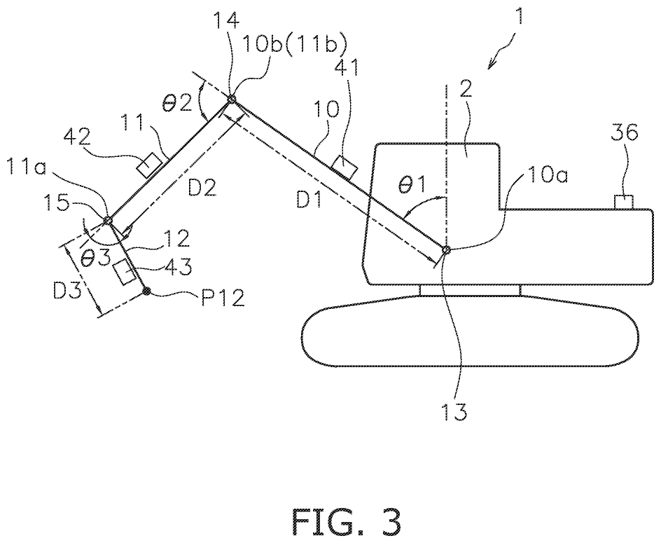

The control system 8 includes a posture sensor 38 of the work implement 3. The posture sensor 38 detects posture data indicating the posture of the work implement 3. The posture sensor 38 includes a boom angle sensor 41 (exemplary postural detection sensor), an arm angle sensor 42, and a bucket angle sensor 43. The posture data include a boom angle, an arm angle, and a bucket angle. The boom angle sensor 41 detects a boom angle θ1. FIG. 3 is a diagram schematically showing a configuration of the work machine 1. As shown in FIG. 3, the boom angle θ1 indicates the tilt angle of the boom 10 in the vehicle body 2.

The arm angle sensor 42 detects an arm angle θ2. The arm angle θ2 indicates the tilt angle of the arm 11 with respect to the boom 10. The bucket angle sensor 43 detects a bucket angle θ3. The bucket angle θ3 indicates the tilt angle of the bucket 12 with respect to the arm 11.

The boom angle sensor 41 is, for instance, an IMU and is attached to the boom 10. A position set on the boom 10 for attaching the boom angle sensor 41 will be described below in detail. The boom angle sensor 41 may be a tilt angle sensor. The arm angle sensor 42 is, for instance, an IMU and is attached to the arm 11. The arm angle sensor 42 may be a tilt angle sensor or may be a sensor that outputs a detection signal indicating the stroke amount of the arm cylinder 17. The bucket angle sensor 43, for instance, outputs a detection signal indicating the stroke amount of the bucket cylinder 18. It should be noted that the bucket angle sensor 43 may be a tilt angle sensor or an IMU. The controller 31 calculates the boom angle θ1, the arm angle θ2, and the bucket angle θ3 based on the detection signals, respectively.

The storage device 32 has stored the shape data of the vehicle body 2 and those of the work implement 3. The shape data of the vehicle body 2 indicate the shape of the vehicle body 2. The shape data of the vehicle body 2 indicate a positional relation between the antenna 36 and a reference position set in the vehicle body 2. The shape data of the vehicle body 2 indicate a positional relation between the reference position set in the vehicle body 2 and the boom pin 13 (the boom foot 10a).

The shape data of the work implement 3 indicate the shape of the work implement 3. The shape data include a boom length D1, an arm length D2, and a bucket length D3. The boom length D1 is the length from the boom pin 13 to the arm pin 14. In other words, the boom length D1 is the length from the boom foot 10a to the boom top 10b. The arm length D2 is the length from the arm pin 14 to the bucket pin 15. The bucket length D3 is the length from the bucket pin 15 to a cutting edge P12 of the bucket 12. The controller 31 calculates bucket position data from the vehicle body position data detected by the position sensor 34 based on the vehicle body tilt angle data, the posture data, and the shape data. The bucket position data indicate the position of the cutting edge P12 of the bucket 12.

The storage device 32 has stored present terrain data and designed terrain data. The present terrain data indicate the present state of the terrain in a work site. The designed terrain data indicate the target shape of the terrain in the work site. The controller 31 causes the display 27 to display the present terrain, the designed terrain, and the position of the work machine 1 (the position of the cutting edge P12 of the bucket 12) based on the present terrain data, the designed terrain data, and the shape data.

### (Position Set on Boom 10 for Attaching Boom Angle Sensor 41)

Next, the position set on the boom 10 for attaching the boom angle sensor 41 will be explained. In the present preferred embodiment, the flexure of the boom 10 is considered in setting the position on the boom 10 for attaching the boom angle sensor 41.

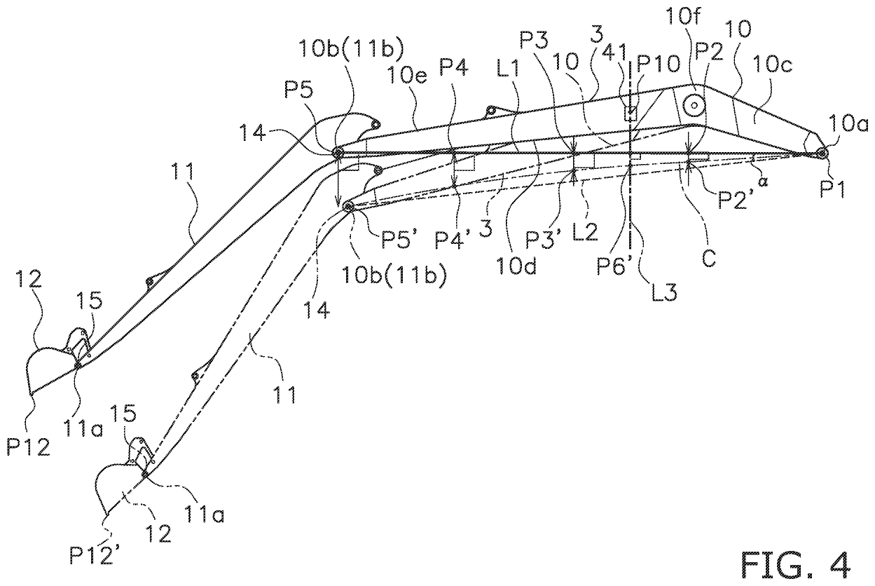

FIG. 4 is a side view of a posture taken by the work implement 3 in a condition that the boom 10 is greatly affected by flexure, i.e., a condition that the boom 10 takes a posture close to horizontal in the lengthwise direction thereof. In FIG. 4, the boom cylinders 16 are each expanded and contracted to a predetermined length, whereby a straight line L1, extending through the boom foot and top 10a and 10b of the boom 10, is arranged along a horizontal direction. In FIG. 4, the work implement 3 in a design phase is depicted with solid line, whereas the work implement 3 in a flexed state is depicted with dashed two-dotted line. In FIG. 4, the arm cylinder 17 is in the maximally contracted state. The position of the cutting edge of the bucket 12 in the work implement 3 in the design phase is indicated by P12, whereas the position of the cutting edge of the bucket 12 in the work implement 3 in the flexed state is indicated by P12′.

The straight line L1 (exemplary first straight line) is obtainable by dimension data in the design phase that have been stored in the storage device 32. The straight line L1 is a straight line in the design phase and connects the boom foot and top 10a and 10b on the premise that the boom 10 is a rigid body in the work implement 3 taking the posture shown in FIG. 4. A line segment of the straight line L1 between the boom foot and top 10a and 10b is quartered at positions sequentially aligned from the position of the boom foot 10a; the positions are defined as P1, P2, P3, P4, and P5. In FIG. 4, the straight line L1 is arranged to be horizontal. The boom foot 10a corresponds to the position P1, whereas the boom top 10b corresponds to the position P5. It should be noted that in the present preferred embodiment, the line segment of the straight line L1 between the boom foot and top 10a and 10b is quartered; however, division of the line segment may not be limited in configuration to this. The line segment may be set in an arbitrary position and may be divided by an arbitrary number of points depending on the length and shape of the boom.

A flexure curve C in a part between the boom foot and top 10a and 10b of the boom 10 is depicted with dashed dotted line. The flexure curve C is obtainable by the FEM analysis based on the straight line L1 in the design phase. The following are examples to be used for the FEM analysis: the shape and dimension of the part between the boom foot and top 10a and 10b of the boom 10 in the design phase, the stiffness of the boom 10, and the properties of a material that the boom 10 is made. Alternatively, the flexure curve C may be obtained by attaching a reflector to the boom 10 and using a laser tracker. As shown in FIG. 4, the flexure curve C curves to bulge upward, while the position P5 of the boom top 10b is moved downward about the position P1 of the boom foot 10a. A straight line, connecting the boom foot and top 10a and 10b on the flexure curve C, is defined as a straight line L2 (exemplary second straight line). The straight line L2 is depicted with broken line.

Determining a position P5′ of the boom top 10b is required for calculating the position P12′ of the teeth of the bucket 12 of the work implement 3 in the flexed state. In the present preferred embodiment, movement in position of the boom top 10b, attributed to flexure, is approximated to rotation in determining the position P5′ of the boom top 10b.

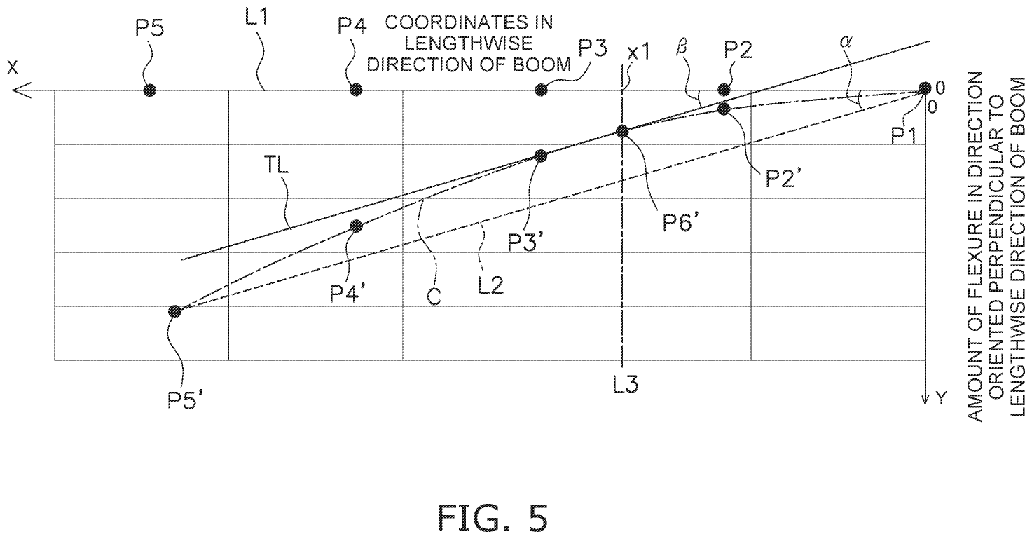

FIG. 5 is a chart showing variation in flexure amount of the boom 10 in a direction oriented perpendicular to the lengthwise direction of the boom 10 with respect to coordinates in the lengthwise direction of the boom 10. In FIG. 5, the horizontal axis (X-axis) is set as the coordinates in the lengthwise direction of the boom 10, whereas the vertical axis (Y-axis) is set as the flexure amount of the boom 10 in the direction oriented perpendicular to the lengthwise direction of the boom 10. The lengthwise direction is a direction oriented from the boom foot 10a toward the boom top 10b and is also a direction oriented along the straight line L1.

In FIG. 5, the straight line L1 corresponds to the horizontal axis. The position P1 of the boom foot 10a on the flexure curve C corresponds to the position of the boom foot 10a in an unflexed state. The position P5′ on the flexure curve shown in FIG. 5 can be set as a position to which the position P5 on the straight line L1 has been moved. The position P2′ on the flexure curve shown in FIG. 5 can be set as a position to which the position P2 on the straight line L1 has been moved. For example, the position P2′ can be set as a position of intersection between the flexure curve C and a straight line that is oriented orthogonal to the straight line L1 and passes through the position P2. The position P3′ on the flexure curve shown in FIG. 5 can be set as a position to which the position P3 on the straight line L1 has been moved. For example, the position P3′ can be set as a position of intersection between the flexure curve C and a straight line that is oriented orthogonal to the straight line L1 and passes through the position P3. The position P4′ on the flexure curve shown in FIG. 5 can be set as a position to which the position P4 on the straight line L1 has been moved. For example, the position P4′ can be set as a position of intersection between the flexure curve C and a straight line that is oriented orthogonal to the straight line L1 and passes through the position P4. It should be noted that as shown in FIG. 4, due to the flexure of the boom 10, the positions P1′ to P5′ are slightly displaced from the positions P1 to P5 in the lengthwise direction.

Next, an angle α (exemplary first angle) formed between the straight line L2 and the straight line L1 (horizontal axis) is obtained; then, a position on the flexure curve C is determined as a position in which an angle β (exemplary second angle) formed between a tangent line TL of the flexure curve C and the straight line L1 (horizontal axis) is identical to the angle α. It should be noted that the angle α is an acute angle formed between the straight line L2 and the straight line L1, whereas the angle β is an acute angle formed between the tangent line TL of the flexure curve C and the straight line L1.

Now, where a, b, c, and d are defined as constants, the flexure curve C can be approximated by the following formula (1).

$$y = a {x}^{4} + b {x}^{3} + c {x}^{2} + dx \qquad Formula ( 1 )$$

The tangent line TL of the flexure curve C can be expressed by the following formula (2) obtained by differentiating the formula (1).

$${y}^{2} = 4 a {x}^{3} + 3 b {x}^{2} + 2 c x + d \qquad Formula ( 2 )$$

Based on the following formula (3), a value of x can be obtained such that the angle β formed between the tangent line TL and the straight line L1 (horizontal axis) is identical to the angle α.

$$α = {y}^{′} = 4 {ax}^{3} + 3 {bx}^{2} + 2 cx + d \qquad Formula ( 3 )$$

The tangent line TL, depicted with solid line in FIG. 5, is obtained such that the angle β and the angle α are identical. The value of x calculated based on the formula (3) is set as x1. Accordingly, a coordinate on the flexure curve C (x1, ax1⁴+bx1³+cx1²+dx1) is obtained; then, a position corresponding to the coordinate is determined as a reference position P6′.

The x-coordinate in the reference position P6′ indicates positional information in the lengthwise direction of the boom 10. Based on the positional information in the lengthwise direction of the boom 10, the position for attachment of the boom angle sensor 41 to the boom 10 may be determined. For example, when the position for attachment of the boom angle sensor 41 to the boom 10 in the design phase is determined, as shown in FIG. 4, it is made possible to determine, as the attachment position P10 of the boom angle sensor 41, a lengthwise directional position that a straight line L3 (exemplary third straight line), which passes through the reference position P6′ and is oriented orthogonal to the straight line L1, intersects with the boom 10 depicted with solid line.

The premise that the boom 10 depicted with solid line is a rigid body may be shown by, for instance, attaching the boom angle sensor 41 to the attachment position P10 shown in FIG. 4 when the posture of the boom 10 is the one taken in an actual state that flexure of the boom 10 is slight without attachment of the arm 11 and the bucket 12 to the boom 10. As shown in FIG. 4, the boom angle sensor 41 is attached to a lateral surface 10c of the boom 10.

It should be noted that, where the lengthwise directional position thereof is constant, the attachment position P10 is not limited to the lateral surface 10c of the boom 10 and may be a ventral surface 10d or a dorsal surface 10e of the boom 10. The ventral surface 10d refers to a lower surface of the boom 10 in FIG. 4, whereas the dorsal surface 10e refers to an upper surface of the boom 10 in FIG. 4. The attachment position P10 is disposed on the boom top 10b side in the vicinity of a bent portion 10f at which the boom 10 is bent. It should be noted that in the explanation described above, the straight line L3, oriented orthogonal to the straight line L1, is used to determine the attachment position P10 of the boom angle sensor 41; however, the one used for determining the attachment position P10 may be a plane oriented orthogonal to the straight line L1 without being limited to the straight line L3. A position, falling in a range of intersection between the plane and the boom 10 depicted with either solid or dashed two-dotted line, may be determined as the attachment position P10.

It should be noted that the position for attachment of the boom angle sensor 41 to the boom 10 in the design phase has been described; however, for instance, when the posture shown in FIG. 4 is taken by the work implement 3 in an actual state, while the boom 10 is flexed as depicted with dashed two-dotted line, the position of intersection of the straight line L3 with the boom 10 depicted with dashed two-dotted line may be set as the attachment position for the boom angle sensor 41. The position for attachment to the boom 10 may be arbitrarily set depending on the actual state of the boom 10 based on the lengthwise directional position of the boom 10 indicated by the x-coordinate in the reference position P6′.

Accordingly, it is made possible to calculate a boom angle including an angle-of-rotation α formed by movement of the boom top 10b caused by flexure from the position P5 to the position P5′. The boom angle θ1, including not only an angle formed by driving of the boom cylinders 16 but also a displacement caused due to flexure, is detectable by the boom angle sensor 41 attached to the attachment position P10.

It should be noted that, for obtaining the attachment position P10, a position on the flexure curve C is obtained such that the angle β formed between the tangent line TL of the flexure curve C and the straight line L1 is identical to the angle α formed between the straight line L2 and the straight line L1; however, the position on the flexure curve C may not be limited to this. As long as the to-be-detected boom angle falls in an allowable error range, a position on the flexure curve C may be obtained as the attachment position P10 such that the angle β falls in a predetermined angular range including the angle α. For example, the following setting may be established: the predetermined angular range=α±the allowable error range. In this case, the attachment position is configured to be ranged in a predetermined region in the lengthwise direction of the boom 10. The allowable error range may be determined based on accuracy in finishing a construction surface (allowable error) as required accuracy and accuracy in measurement by the boom angle sensor 41 (tolerance). For example, the allowable error range may be determined based on difference between the accuracy in finishing the construction surface (allowable error) and the accuracy in measurement by the boom angle sensor 41 (tolerance). Based on the angle α and the allowable error range, the predetermined angular range may be determined as an allowable angular range of the angle β.

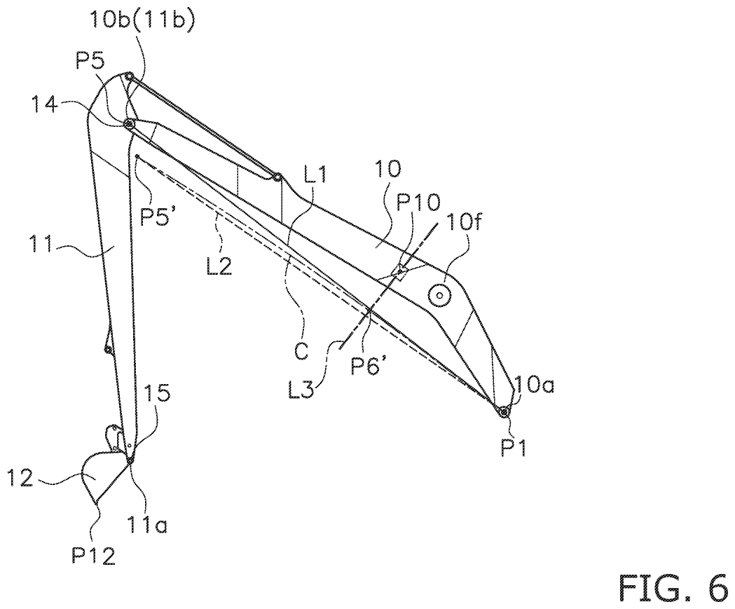

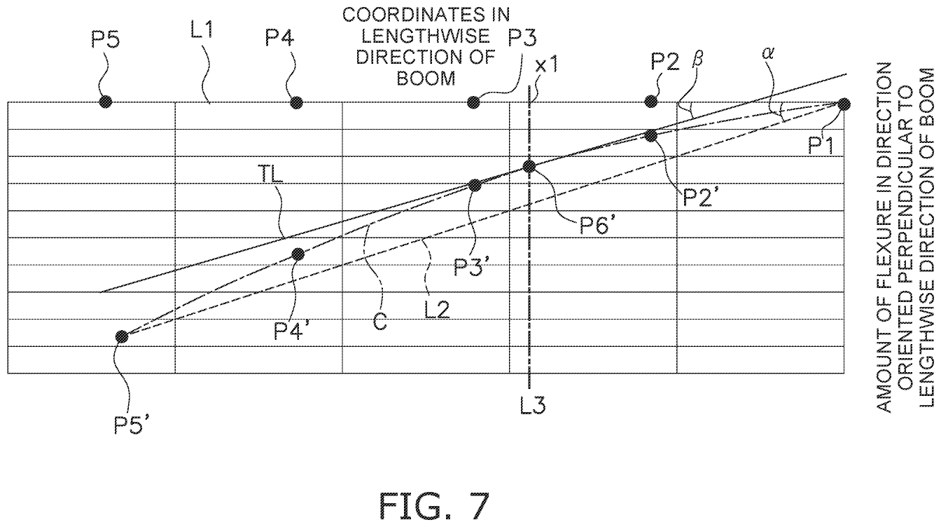

FIG. 6 exemplifies a posture taken by the work implement 3 when work accuracy is required. FIG. 6 is a side view of the posture taken by the work implement 3 such that the arm 11 is oriented along the up-and-down direction. In the posture of the work implement 3 shown in FIG. 6, the cutting edge P12 of the bucket 12 is in contact with the ground. FIG. 7 is a chart of the flexure curve C of the boom 10 in the work implement 3 taking the posture shown in FIG. 6. In a manner comparable to FIG. 5, the horizontal axis in the chart of FIG. 7 is set as coordinates in the lengthwise direction of the boom 10, whereas the vertical axis in the chart of FIG. 7 is set as the amount of flexure in the direction oriented perpendicular to the lengthwise direction of the boom 10. Besides, in FIG. 7, the straight line L1 corresponds to the horizontal axis. Likewise in FIG. 7, in a manner comparable to FIG. 5, the flexure curve C is obtained based on the straight line L1 connecting the boom foot 10a and the boom top 10b of the work implement 3 taking the posture shown in FIG. 6 in the design phase; then, the straight line L2, passing through the boom foot 10a and the boom top 10b on the flexure curve C, is obtained. Subsequently, the angle α formed between the straight line L1 and the straight line L2 is obtained; then, a position on the flexure curve C is obtained such that the angle β formed between the tangent line TL of the flexure curve C and the straight line L1 is identical to the angle α. The position herein obtained, i.e., the attachment position P10 for attachment to the boom 10 in the design phase, is depicted in FIG. 6. The attachment position P10 shown in FIG. 6 is approximately identical in location to that shown in FIG. 4 and is disposed on the boom top 10b side of the bent portion 10f. The attachment position for the boom angle sensor 41 may be set as either the attachment position P10 shown in FIG. 4 or that shown in FIG. 6, or alternatively, as a position between the attachment position P10 shown in FIG. 4 and that shown in FIG. 6.

By attaching the boom angle sensor 41 to the attachment position obtained as described above, it is made possible to detect the boom angle including the amount of flexure; hence, it is made possible to reduce a positional error caused due to flexure of the boom 10. Accordingly, it is made possible to accurately detect the position P12 of the cutting edge of the bucket 12 as well. It should be noted that in a manner comparable to the boom 10 described above, an attachment position may be set on the arm 11; then, the arm angle sensor 42 may be attached to the arm 11. However, chances are that the boom 10 takes a posture to extend along a horizontal direction, whereby the boom 10 is likely to be flexed. By contrast, chances are that the arm 11 takes a posture to extend in the up-and-down direction, whereby the arm 11 is unlikely to be flexed. Hence, unlike on the boom 10, the attachment position may not be set on the arm 11.

### (Method of Attaching Boom Angle Sensor 41 to Boom 10)

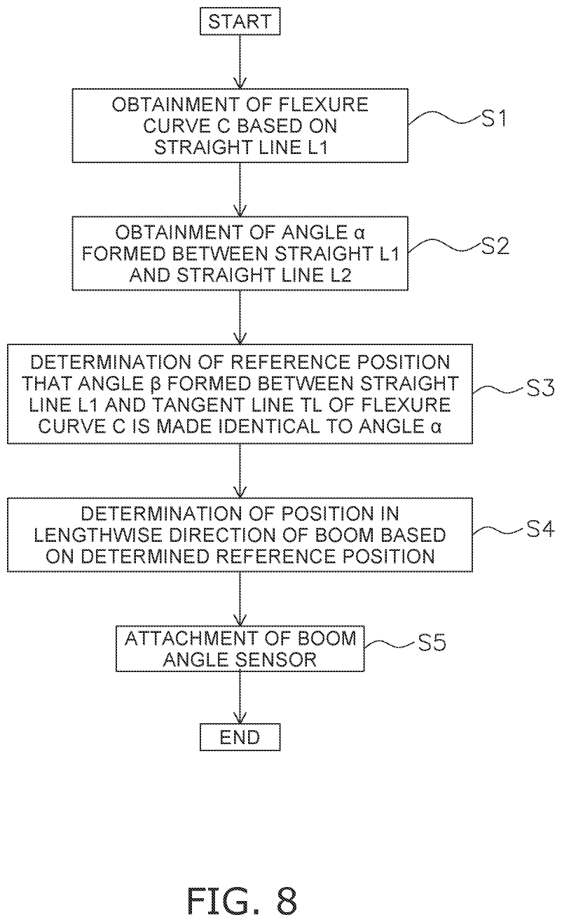

Next, a method of attaching the boom angle sensor 41 to the boom 10 will be described; simultaneously, an attachment position determining method will be exemplified as well. FIG. 8 is a flowchart for explaining the method of attaching the boom angle sensor 41 to the boom 10.

First, in step S1, the flexure curve C between the boom foot 10a and the boom top 10b on the boom 10 is obtained based on the straight line L1 connecting the boom foot 10a and the boom top 10b of the boom 10 in the design phase. The straight line L1 in the design phase has been stored in the storage device 32. The flexure curve C is obtainable by, for instance, the FEM analysis or so forth as described above.

Next, in step S2, the angle α is obtained that is formed between the straight line L2 connecting the boom foot 10a and the boom top 10b on the flexure curve C and the straight line L1 connecting the boom foot 10a and the boom top 10b in the design phase.

Next, in step S3, a position on the flexure curve C is determined as the reference position P6′ such that the angle β formed between the tangent line TL of the flexure curve C and the straight line L1 is identical to the angle α.

Next, in step S4, the attachment position P10 in the lengthwise direction of the boom 10, corresponding to the reference position P6′ on the flexure curve C, is determined. When flexure of the boom 10 is slight, for instance, it is made possible to determine, as the attachment position P10, a position on the boom 10 intersecting with the straight line L3 that is oriented perpendicular to the straight line L1 and passes through the reference position P6′.

Next, in step S5, the boom angle sensor 41 is attached to the attachment position P10.

Through the steps described above, it is made possible to set the attachment position P10 in consideration of flexure of the boom 10 and attach the boom angle sensor 41 to the attachment position P10.

### (Features Etc.)

As described above, a position on the flexure curve C is determined as the reference position P6′ such that the angle α formed between the straight line L1 and the straight line L2 is equal to the angle β formed between the tangent line TL of the flexure curve C and the straight line L1; besides, the attachment position P10 for the boom angle sensor 41 on the boom 10 is determined based on the positional information in the lengthwise direction of the boom 10 among the positional information of the reference position P6′. Because of this, when the value of the boom angle θ1 is detected by the boom angle sensor 41, flexure is considered as well, whereby it is made possible to reduce an error in detection by the boom angle sensor 41 caused due to inconsideration of flexure.

Besides, either the straight line L3 or the plane is obtained that passes through the reference position P6′ and is oriented orthogonal to the straight line L1; then, the attachment position P10 for the boom angle sensor 41 on the boom 10 is determined based on the range of intersection between the boom 10 and either the straight line L3 or the plane. Thus, it is made possible to determine the attachment position P10 on the boom 10.

Furthermore, the attachment position for the boom angle sensor 41 on the boom 10 is determined by the attachment position determining method according to the present disclosure; hence, it is made possible to retrofit the boom angle sensor 41 to the attachment position.

### Other Embodiments

One preferred embodiment of the present invention has been explained above. However, the present invention is not limited to the preferred embodiment described above, and a variety of changes can be made without departing from the gist of the present invention.

### (A)

In the preferred embodiment described above, the flexure curve is obtained based on the boom foot 10a, to which the boom pin 13 is inserted, and the boom top 10b, to which the arm pin 14 is inserted; however, portions served as the bases for obtaining the flexure curve are not strictly limited to the boom foot 10a and the boom top 10b. The portions may be arbitrarily set so long as regarded as the distal end portion and the base end portion of the boom 10.

### (B)

In the preferred embodiment described above, the position of the cutting edge 12p of the bucket 12 is obtained; however, the position to be obtained may not be limited to the position of the cutting edge 12p. Another position other than the cutting edge 12p of the bucket 12 may be obtained. Based on this position and the shape data of the bucket 12, it is made possible to display the posture of the bucket 12 on the display.

### (C)

In the preferred embodiment described above, by assuming both postures taken by the work implement 3 as shown in FIGS. 4 and 6, the flexure curve C is obtained; then, the attachment position for the boom angle sensor 41 is obtained. However, the postures of the work implement 3, assumed to determine the attachment position for the sensor, are not limited to those shown in FIGS. 4 and 6. The attachment position for the sensor may be determined by assuming a posture taken by the work implement in a work requiring high work accuracy such as a work for forming a slope. The attachment position for the sensor may be determined by assuming a posture, at which the work implement is greatly affected by flexure, such as a posture taken by the work implement extending in a horizontal direction. The attachment position for the sensor may be determined by assuming a posture taken by the work implement in consideration of the content of work, the shape of the work machine, or the terrain of a work site.

### (D)

The work machine 1 is not limited to the hydraulic excavator described above; alternatively, the work machine 1 may be another type of machine such as a mechanical shovel or a rope shovel. The work machine 1 according to the preferred embodiment described above is an excavator of a so-called backhoe type, but alternatively, may be an excavator of a face shovel type. Besides, the lower structure is not limited to be composed of the crawler belts, and alternatively, may be composed of wheels. Alternatively, the lower structure may be a hull for a barge or so forth. In other words, the work machine 1 may be a dredger equipped with a work implement including a boom.

### (E)

In the preferred embodiment described above, the bucket 12 is attached to the distal end of the arm 11 as an exemplary attachment; however, the attachment may not be limited to this. For example, a breaker or so forth may be attached thereto.

According to the present disclosure, it is made possible to provide an attachment position determining method, a work implement, a work machine, and a postural detection sensor, whereby it is made possible to reduce a detection error caused in postural detection due to inconsideration of flexure.

1. An attachment position determining method for a postural detection sensor in a work implement including a link member, the postural detection sensor being configured to detect a posture of the link member, the attachment position determining method comprising:
obtaining a first straight line connecting a base end portion and a distal end portion of the link member in a design phase;
obtaining a flexure curve indicating a flexed state of the link member, the flexure curve being obtained based on the first straight line;
obtaining a second straight line connecting the base end portion and the distal end portion on the flexure curve;
obtaining a first angle formed between the first straight line and the second straight line;
obtaining a second angle formed between the first straight line and a tangent line of the flexure curve;
determining a position on the flexure curve as a reference position such that the second angle is equal to the first angle; and
determining an attachment position of the postural detection sensor on the link member based on positional information in a lengthwise direction of the link member of positional information of the reference position.

2. The attachment position determining method according to claim 1, wherein
determining the attachment position for the postural detection sensor on the link member based on the positional information in the lengthwise direction of the link member of the positional information of the reference position includes
obtaining a third straight line or a plane passing through the reference position, the the third straight line or the plane being oriented orthogonal to the first straight line, and
determining the attachment position of the postural detection sensor on the link member based on a range of intersection between the link member and the the first straight line or the plane.

3. The attachment position determining method according to claim 1, wherein
the link member is a boom.

4. The attachment position determining method according to claim 1, wherein
the link member is an arm.

5. The attachment position determining method according to claim 1, wherein
the first straight line is obtained based on a posture of the work implement when the flexed state is maximized.

6. The attachment position determining method according to claim 1, wherein
the first straight line is obtained based on a posture of the work implement when the base end portion and the distal end portion are oriented horizontal.

7. The attachment position determining method according to claim 1, wherein
the work implement further includes a second link member, the second link member being rotatably attached to the distal end portion of the link member, and
the first straight line is obtained based on a posture of the work implement when the second link member extends in an up-and-down direction.

8. A work implement including the attachment position determined by the attachment position determining method according to claim 1, the work implement further comprising:
the link member including the base end portion and the distal end portion.

9. A work implement including the attachment position determined by the attachment position determining method according to claim 1, the work implement further comprising:
the link member including the base end portion and the distal end portion; and
the postural detection sensor attached to the attachment position on the link member, the postural detection sensor detecting the posture of the link member.

10. A work machine including the work implement according to claim 8, the work machine further comprising:
a lower structure; and
a revolving unit disposed to be revolvable on an upper side of the lower structure
the work implement being rotatably attached to the revolving unit at the base end portion of the link member, and
the work implement further including
a second link member rotatably attached to the distal end portion of the link member, and
an attachment attached to the second link member.

11. A postural detection sensor attachable to the attachment position on the link member to detect the posture of the link member, the attachment position being determined by the determining method according to claim 1.
